(19) United States
(12) Patent Application Publication
(10) Pub. No.: US 2018/0164580 A1
(43) Pub. Date: Jun. 14, 2018

(54) OPTICAL MICRO MIRROR ARRAYS

(71) Applicant: Intel Corporation, Santa Clara, CA (US)

(72) Inventors: Ginni Grover, Santa Clara, CA (US); Sasha N. Oster, Chandler, AZ (US); Feras Eid, Chandler, AZ (US); Seth E. Hunter, Santa Clara, CA (US)

(21) Appl. No.: 15/376,414

(22) Filed: Dec. 12, 2016

(51) Int. Cl. G02B 26/08; C23C 30/00

(52) U.S. Cl. CPC G02B 26/0833; C23C 30/00

(57) ABSTRACT

Embodiments include techniques and configurations for apparatuses and methods for making an optical imaging device based on a micro mirror array. The method may include forming an array of trenches in a substrate. The array of trenches may be formed by intersecting a first plurality of walls with a second plurality of walls in the substrate. A trench of the array of trenches may be formed by adjacent walls of the first plurality of walls and intersecting adjacent walls of the second plurality of walls. A wall of the trench may include a side surface coupled with a top surface. A reflective layer may be deposited conformally to cover the side surface of the wall and to serve as a reflector. A supporting layer may be formed above the substrate, or within the array of trenches, to provide mechanical support for the array of trenches. Other embodiments may be claimed.

### TECHNICAL FIELD

The present disclosure relates to the field of optical imaging devices. More particularly, the present disclosure relates to optical imaging devices based on micro mirror arrays.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Optical imaging devices, e.g., imaging plates, based on micro mirror arrays may be used as display devices. Different from lenses that form images by refraction of light, micro mirror array based optical imaging devices may form images by reflection of light from surfaces of the micro mirror array. As a result, a micro mirror array based optical imaging device may form a floating image, hiding the original object from a viewer's eye. An imaging plate based on a micro mirror array may be made using orthogonal micro mirrors acting as retro-reflectors along two dimensions, in the plane of the plate. A method for making a micro mirror array in two layers may first make rows of micro mirrors in a layer, and then columns of micro mirrors in another layer. Such a method may be time intensive and costly, which may limit the production, and prevent micro mirror array based optical imaging devices from being widely used.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1(a)-1(c) illustrate an optical imaging device based on a micro mirror array creating a floating image of an object for a viewer, according to various embodiments.

FIG. 2 illustrates a flow chart of a process for making an optical imaging device based on a micro mirror array in a substrate, according to various embodiments.

FIGS. 3, 4, 5(a), and 5(b) illustrate three-dimensional view details of the process shown in FIG. 2 for making an optical imaging device based on a micro mirror array formed in an array of trenches within a substrate, according to various embodiments.

FIGS. 6(a)-6(d) illustrate cross-section views of an apparatus at various stages of fabrication following a process for making an optical imaging device based on a micro mirror array in a substrate, according to various embodiments.

FIGS. 7(a)-7(c) illustrate an embodiment of making an array of trenches in a substrate, according to various embodiments.

FIGS. 8(a)-8(c) illustrate another embodiment of making an array of trenches in a substrate, according to various embodiments.

FIG. 9 illustrates an example computing device that may employ the apparatuses and/or methods described herein, according to various embodiments.

### DETAILED DESCRIPTION

Embodiments of the present disclosure include techniques and configurations for apparatuses and methods for making an optical imaging device based on a micro mirror array, which may create a floating image of an object for a viewer. Embodiments for making such an optical imaging device based on a micro mirror array may utilize semiconductor packaging and microfabrication techniques. Instead of making the micro mirror array in two distinct layers, the techniques herein may make a micro mirror array in a substrate in the same layer using batch fabrication processes. Techniques described herein may produce micro mirror array based optical imaging devices faster and cheaper than other processes. The substrate used to make a micro mirror array based optical imaging device may include a ceramic material, e.g., glass, or a polymer material, e.g., polydimethylsiloxane (PDMS) or polymethyl methacrylate (PMMA).

In some embodiments, a method for making an optical imaging device may include forming an array of trenches in a substrate. The array of trenches may be formed by intersecting a first plurality of walls with a second plurality of walls in the substrate. A trench of the array of trenches may be formed by adjacent walls of the first plurality of walls and intersecting adjacent walls of the second plurality of walls. A wall of the trench may include a side surface coupled with a top surface. The method for making the optical imaging device may further include depositing a reflective layer conformally covering the side surface of the wall of the trench of the array of trenches to serve as a reflector; forming a supporting layer above the substrate, or within the array of trenches, to provide mechanical support for the array of trenches; and forming a privacy film covering the supporting layer.

In some embodiments, an optical imaging device may include an optically transparent substrate having an array of trenches formed by a first plurality of walls intersecting with a second plurality of walls in the substrate. A trench of the array of trenches may be formed by adjacent walls of the first plurality of walls and intersecting adjacent walls of the second plurality of walls. A wall of the trench may include a side surface coupled with a top surface. The optical imaging device may further include a reflective layer disposed on the substrate to conformally cover the side surface of the wall of the trench of the array of trenches to serve as a reflector. In addition, the optical imaging device may include a supporting layer disposed above the substrate, or within the array of trenches, to provide mechanical support for the array of trenches, and a privacy film covering the supporting layer.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The description may use the phrase “communicatively coupled.” The phrase may mean that an electrical signal may propagate among the elements that are communicatively coupled.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

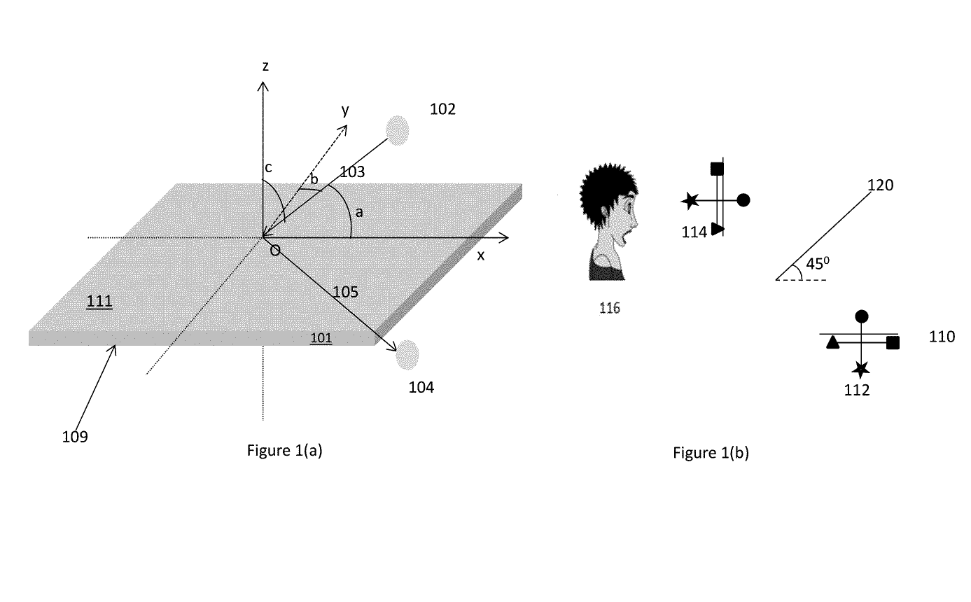

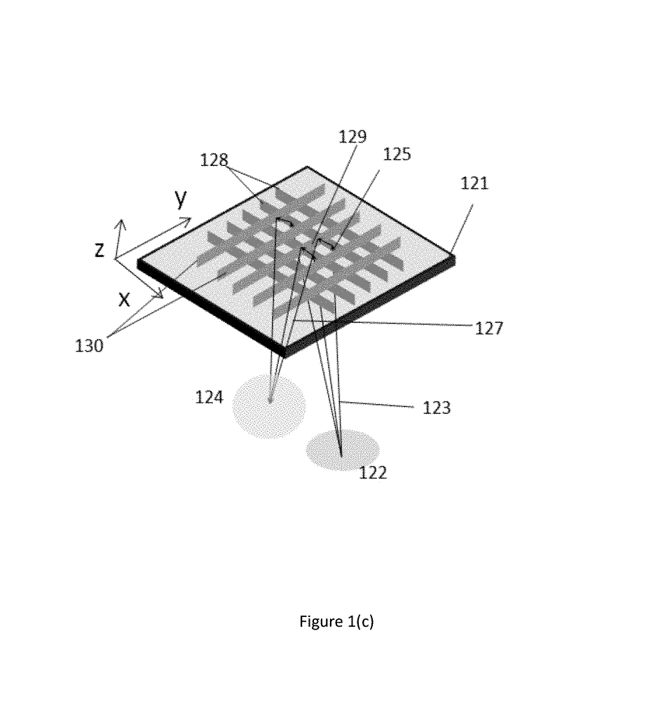

FIGS. 1(a)-1(c) illustrate an optical imaging device based on a micro mirror array configured to create a floating image of an object for a viewer, according to various embodiments. Traditionally, an image may be formed by a lens based on refraction of light. Refraction may happen when light is deflected while going through a substance. In embodiments, an optical imaging device based on a micro mirror array may form an image based on reflection of light. Reflection may happen when light is bounced off from a surface of a substance, instead of going through the substance.

FIG. 1(a) illustrates a three-dimensional view of an optical imaging device 101 based on a micro mirror array. The optical imaging device 101 may be placed horizontally, while an object 102 may be above a top surface 111 of the optical imaging device 101. In embodiments, the object 102 may be a flat object or a three-dimensional object. A light ray 103 coming from the object 102 may enter the optical imaging device 101 through the top surface 111 at a point O. The light ray 103 may have a direction of (a, b, c) in a three-dimensional coordinate system, (x, y, z), with the point O as the coordinate system's origin. After hitting the optical imaging device 101 at point O, the light ray 103 may reflect from multiple mirror surfaces inside the optical imaging device 101 and may exit a bottom surface 109 as a light ray 105. The light ray 105 may exit from the bottom surface 109 with a direction (−a, −b, c), where the direction along z of the light ray 105 may be the same as the direction along z of the light ray 103. On the other hand, the x direction and the y direction of the light ray 105 may have each been exactly reversed as compared to the light ray 103. Similarly, all light rays from the object 102 may enter the optical imaging device 101 through the top surface 111 and exit through the bottom surface 109 following the same convention for their directions. The light rays exiting from the optical imaging device 101 may converge to create an image 104 for the object 102.

FIG. 1(b) illustrates an optical imaging device 120 based on a micro mirror array. In embodiments, the optical imaging device 120 may be tilted at an approximately 45 degree angle from a horizontal surface 110. An object 112 may be placed on the horizontal surface 110. The object 112 may create an image 114 through the optical imaging device 120, where the image 114 may be rotated by 90 degrees with respect to the object, based on a similar pattern as demonstrated in FIG. 1(a). While the object 112 may be flat and placed in a horizontal direction, the image 114 may become vertical in front of a viewer 116 after being rotated by 90 degrees. In embodiments, the optical imaging device 120 tilted at an approximately 45 degree angle from a horizontal surface is only one example to show how the optical imaging device 120 may be used. In some other embodiments, the optical imaging device 120 may be placed in various positions and angles and to create different imaging results for a viewer.

FIG. 1(c) illustrates an optical imaging device 121 based on a micro mirror array, with more details of the micro mirror array. In embodiments, the optical imaging device 121 may include rows of mirrors 130, and columns of mirrors 128, where the rows of mirrors 130 may be placed in a direction orthogonal to the direction of the columns of mirrors 128. The flat surfaces of the rows of mirrors 130 and the flat surfaces of the columns of mirrors 128, orthogonal to each other, form two surfaces of a retro-reflector. When light coming from an object 122 enters the optical imaging device 121, those surfaces reflect the light in the plane of the optical imaging device 121 along the x and y directions. The light then exits the optical imaging device 121 to create an image, e.g., an image 124, of the object 122.

In more details, a light ray 123 coming from the object 122 may enter the optical imaging device 121, hitting a column of mirrors 125. The light may then be bounced along the column of mirrors 125 to hit a row of mirrors 129, and finally exit the optical imaging device 121 as a light ray 127. Similarly, all light rays from the object 122 may travel similar paths hitting and getting reflected from rows of mirrors 130 and columns of mirrors 128 in the optical imaging device 121, forming an image 124. The light rays exiting from the optical imaging device 121 may converge to create the image 124 of the object 122.

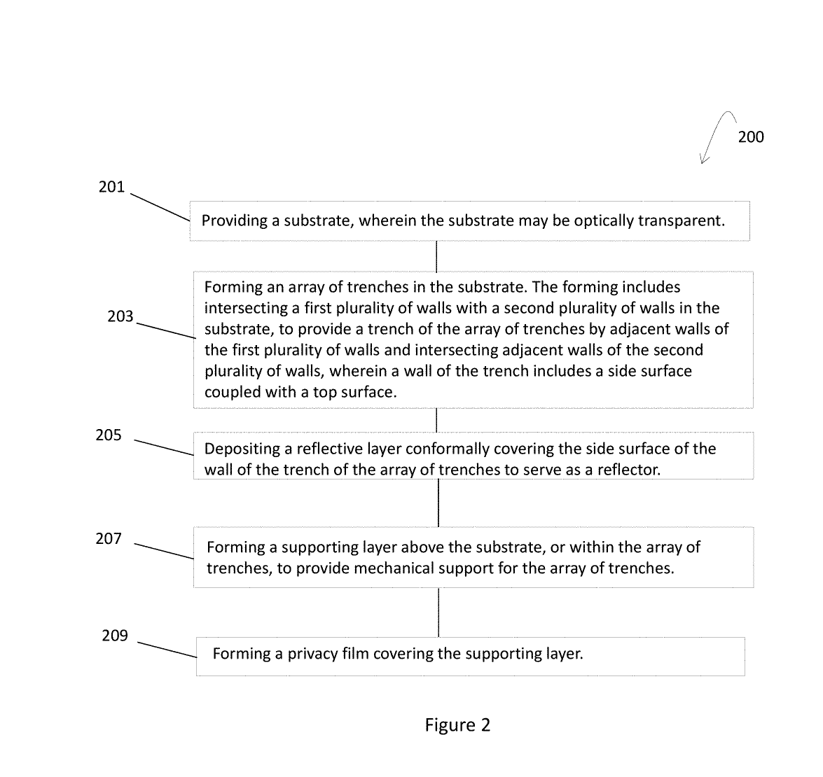

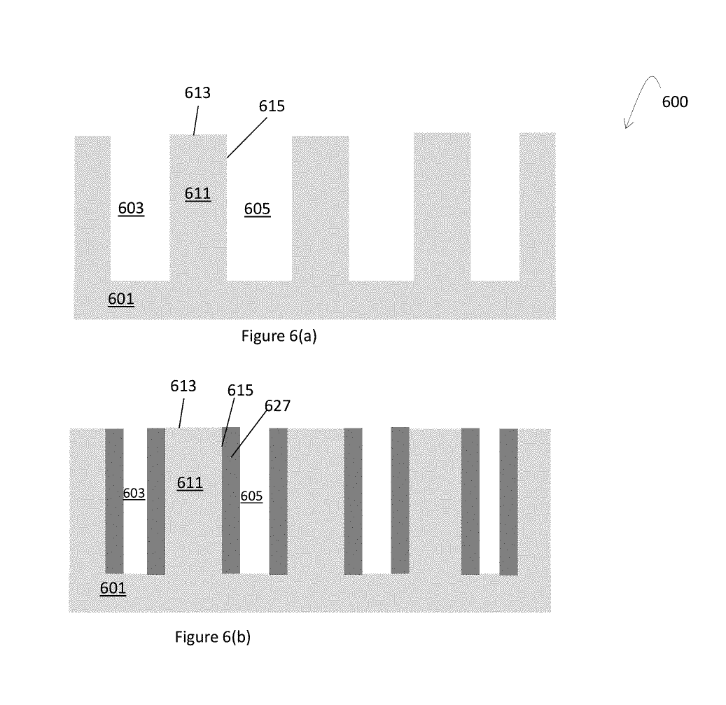

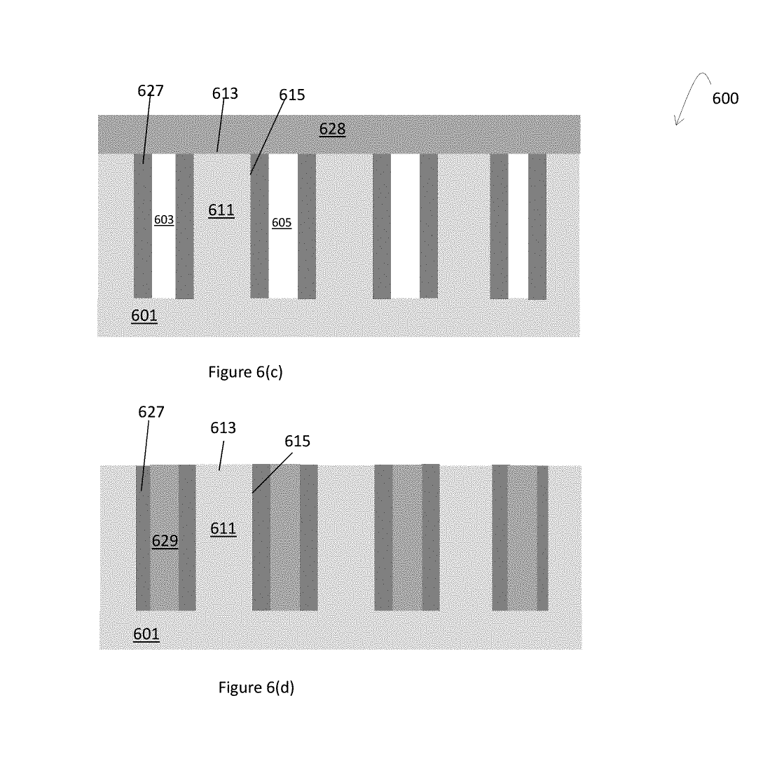

Embodiments herein may make the optical imaging device 121 by utilizing semiconductor packaging and microfabrication techniques, as demonstrated by the processes illustrated in FIG. 2 and FIG. 6. In doing so, the rows of mirrors 130 and the columns of mirrors 128 of the optical imaging device 121 may be made in a substrate, by either making two separate layers of rows and columns or making both the columns and rows in the same layer.

FIG. 2 illustrates a flow chart of an example process 200 for making an optical imaging device based on a micro mirror array in a substrate, according to various embodiments. The process 200 may be applied to make the optical imaging device 101, the optical imaging device 120, or the optical imaging device 121, as shown in FIGS. 1(a)-1(c).

In block 201, the process 200 may include providing a substrate, wherein the substrate may be optically transparent. In some embodiments, the substrate may include a ceramic material, e.g., glass, or a polymer material, e.g., PMMA, plastic, or PDMS. In some embodiments, the substrate may have a width or length in a range of about 100 mm to about 500 mm. In some other embodiments, the substrate may have a thickness in a range of about 0.25 mm to about 1.5 mm per layer up to a total thickness of about 4.5 mm for a two layer embodiment.

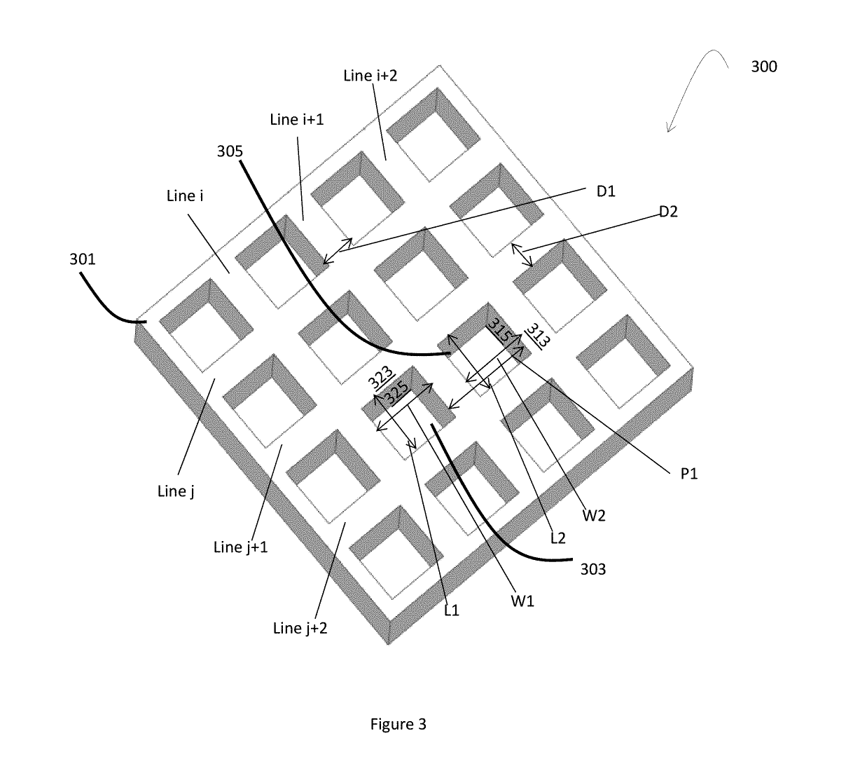

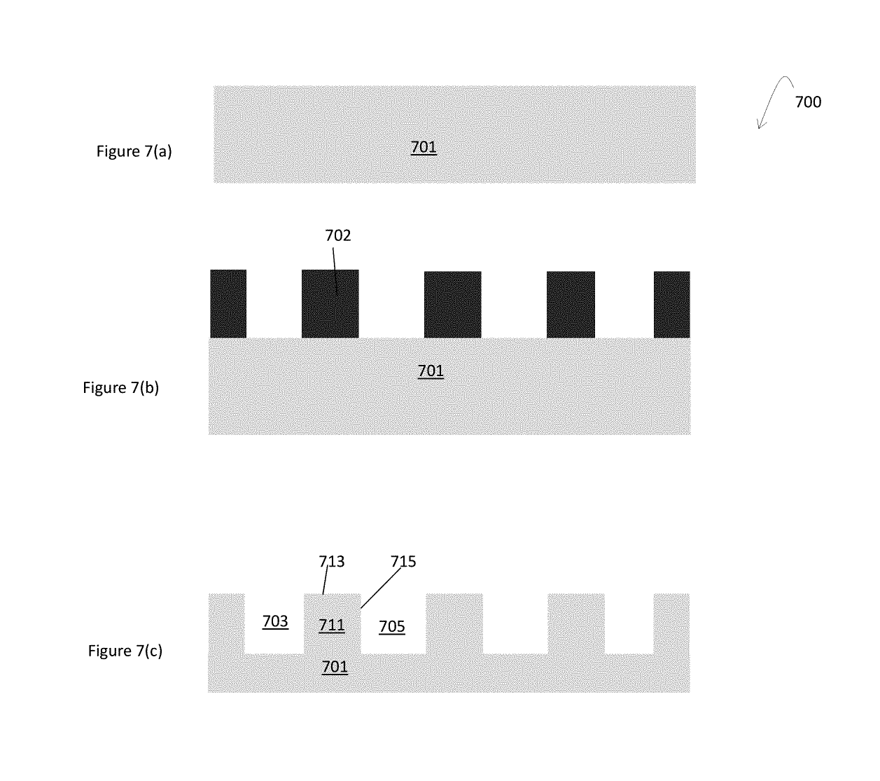

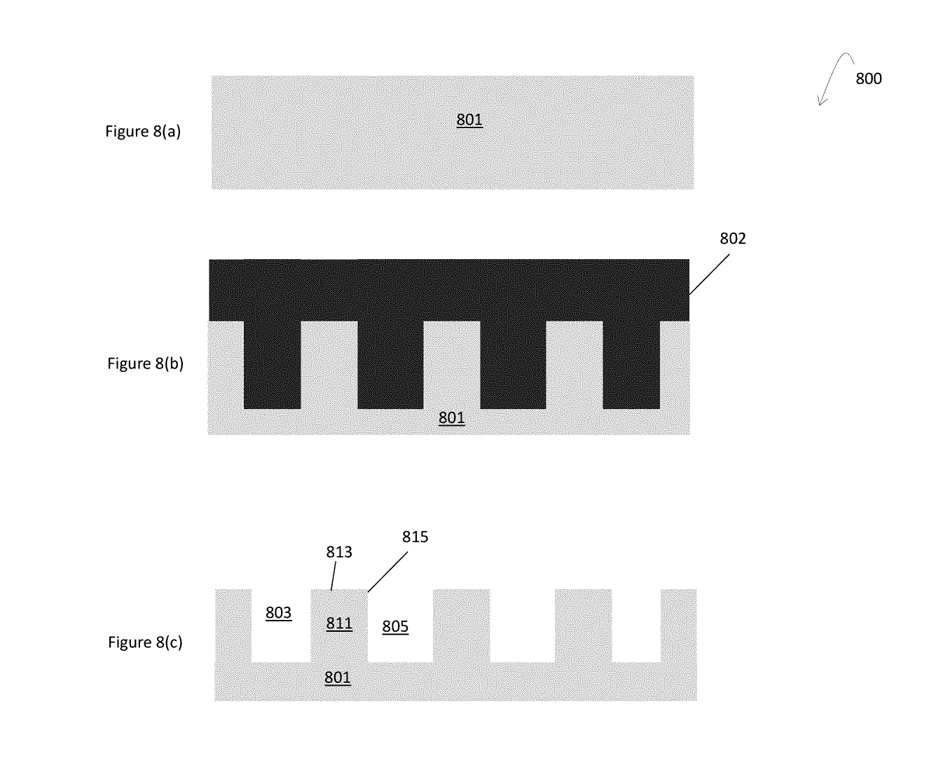

In block 203, the process 200 may include forming an array of trenches in a substrate. In some embodiments, the array of trenches may be formed by intersecting a first plurality of walls with a second plurality of walls in the substrate. More detailed processes for forming the array of trenches may be shown in FIGS. 7(a)-7(c), or in FIGS. 8(a)-8(c). FIG. 3 shows an example of the array of trenches formed by operations in block 203 and will be described below in detail.

In embodiments, a trench of the array of trenches may be formed by adjacent walls of the first plurality of walls and intersecting adjacent walls of the second plurality of walls. In some embodiments, the array of trenches may be formed by intersecting the first plurality of walls substantially orthogonally to the second plurality of walls. In some embodiments, the trench of the array of trenches may extend through the substrate, as shown in FIG. 3. In some other embodiments, the trench of the array of trenches may extend partially through the substrate, for example, as shown in FIGS. 6(a)-6(d). A wall of the trench may include a side surface coupled with a top surface.

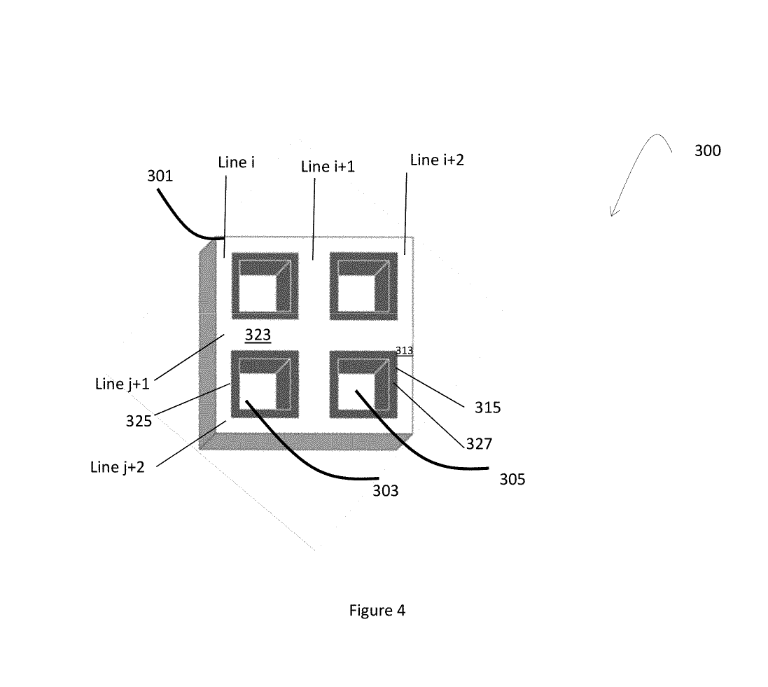

In block 205, the process 200 may include depositing a reflective layer conformally covering the side surface of the wall of the trench of the array of trenches to serve as a reflector. FIG. 4 shows an example of the reflective layer conformally covering the side surface of the wall of the trench of the array of trenches to serve as a reflector. In embodiments, the reflective layer may include aluminum, gold, silver, or other reflective materials.

To form the reflective layer, a photoresist layer or a sacrificial layer may be deposited and patterned in locations where the reflective layer may not be desired, such as a middle portion of the trench of the array of trenches or top surface of the wall 613 in FIG. 6. The photoresist layer or the sacrificial layer may be deposited by lamination, coating, or other techniques. Afterwards, a reflective material may be deposited on the substrate, to form a reflective layer in the area not covered by the photoresist layer or the sacrificial layer, e.g., the side surface of the wall of the trench of the array of trenches. In some embodiments, the reflective material may cover the photoresist layer or the sacrificial layer as well. Finally, the photoresist layer or the sacrificial layer may be removed, leaving the reflective layer in the desired locations, e.g., the side surface of the wall of the trench of the array of trenches. Alternatively, the reflective layer may be formed by selectively treating desired locations, e.g., the side surface of the wall of the trench of the array of trenches, with adhesion promoters. Afterwards, the reflective material may be deposited so that the reflective material may only adhere to the treated locations to form the reflective layer.

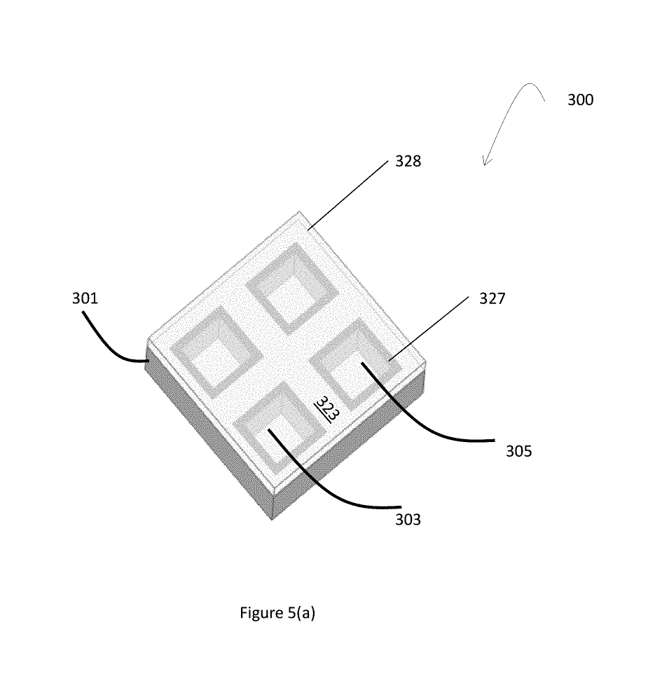

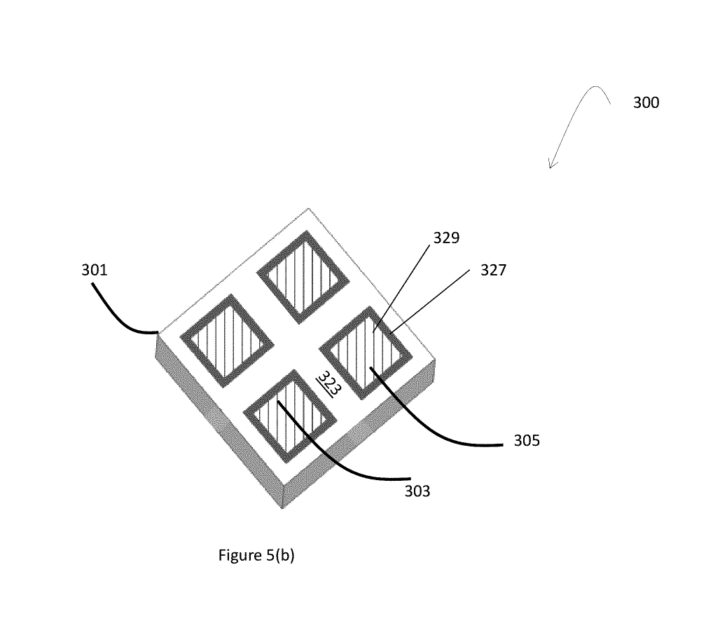

In block 207, the process 200 may include forming a supporting layer above the substrate, or within the array of trenches, to provide mechanical support for the array of trenches. FIG. 5(a) shows an example of the supporting layer formed above the substrate, while FIG. 5(b) shows an example of the supporting layer formed within the array of trenches.

The supporting layer may improve the mechanical stiffness and/or rigidity of the optical imaging device with little impact on the optical properties. For example, the supporting layer may keep the surfaces of the optical imaging device clean and damage free. In addition, the supporting layer may provide support to the walls of the trench of the array of trenches, preventing the walls from breaking and/or failing. In some embodiments, the supporting layer disposed above the substrate may include a flat sheet of an optically transparent material, such as glass. In some other embodiments, the supporting layer disposed within the array of trenches may include an optically transparent material filling the array of trenches, such as PDMS or PMMA. When the supporting layer is disposed within the array of trenches, the supporting layer may have a flat top surface at a same or similar level as the top surface of the walls of the array of trenches.

In block 209, the process 200 may optionally include forming a privacy film covering the supporting layer. In embodiments, the privacy film may be deposited above the supporting layer. The privacy film may eliminate unwanted secondary images by the optical imaging device, or other unwanted effects.

FIGS. 3-5 illustrate three-dimensional view details of the process shown in FIG. 2 for making an optical imaging device 300 based on a micro mirror array formed in an array of trenches within a substrate 301, according to various embodiments.

FIG. 3 illustrates a three-dimensional view of the optical imaging device 300 having an array of trenches formed in the substrate 301, according to various embodiments. The array of trenches may be formed as a result of the operations shown in block 203 of FIG. 2. In embodiments, the array of trenches may be formed by processes shown in FIGS. 7(a)-7(c), or in FIGS. 8(a)-8(c).

In embodiments, the substrate 301 may include a ceramic material, e.g., glass, or a polymer material, e.g., PMMA, plastic, or PDMS, in which the trenches are to be formed. When the substrate includes a ceramic material, e.g., glass, the array of trenches may be formed by lithography techniques using photoresist materials, followed by selective removal of the ceramic material, as shown in FIGS. 7(a)-7(c), to form the desired pattern. Alternatively, when the material in which the trenches are to be formed is a polymer material, e.g., PDMS or PMMA, the array of trenches may be formed by embossing this material with a hard template or stamp, as shown in FIGS. 8(a)-8(c), to form the desired pattern.

In the substrate 301, a first plurality of walls may be provided along a first direction, such as a wall of a line i, a wall of a line i+1, and a wall of a line i+2. The wall of the line i, the wall of the line i+1, and the wall of the line i+2 may be substantially parallel to each other, and may have a similar width, e.g., D1. A wall of the first plurality of walls may include a side surface coupled with a top surface. For example, the wall of the line i+2 may include a top surface 313 and a side surface 315 coupled with the top surface 313. In some embodiments, the wall of the line i, the wall of the line i+1, and the wall of the line i+2 may be referred to as rows of walls.

In the substrate 301, a second plurality of walls may be provided along a second direction, such as a wall of a line j, a wall of a line j+1, and a wall of a line j+2. In embodiments, the second direction may be substantially orthogonal to the first direction. The wall of the line j, the wall of the line j+1, and the wall of the line j+2 may be substantially parallel to each other, and may have a similar width, e.g., D2. In embodiments, the width D2 may be equal to or different from the width D1 for the first plurality of walls. The width D1 and/or D2 may be as small as physically allowed by a manufacturing process. A wall of the second plurality of walls may include a side surface coupled with a top surface. For example, the wall of the line j+1 may include a top surface 323 and a side surface 325 coupled with the top surface 323. In some embodiments, the wall of the line j, the wall of the line j+1, and the wall of the line j+2 may be referred to as columns of walls.

In some embodiments, the array of trenches may be formed by intersecting the first plurality of walls with the second plurality of walls. In some embodiments, the intersection of the first plurality of walls with the second plurality of walls may be substantially orthogonal. For example, the wall of the line i, the wall of the line i+1, and the wall of the line i+2 may intersect, substantially orthogonally, with the wall of the line j, the wall of the line j+1, and the wall of the line j+2 to form the array of trenches.

A trench, e.g., a trench 303 or a trench 305, may be formed by adjacent walls of the first plurality of walls and intersecting adjacent walls of the second plurality of walls. In more detail, the trench 303 may be formed by the wall of the line i, and the wall of the line i+1 which is adjacent to the wall of the line i, intersecting with the wall of the line j+1, and the wall of the line j+2 that is adjacent to the wall of the line j+1. In some embodiments, the trench of the array of trenches may extend completely through the substrate in the vertical direction (i.e., the direction perpendicular to the top surfaces 323 and 313). For example, the trench 303 and the trench 305 may extend completely through the substrate 301 in the vertical direction.

In embodiments, a cross-section of a trench of the array of trenches may be of a substantially rectangular shape or a square shape. For example, the cross-section of the trench 303 and the cross-section of the trench 305 may be of a rectangular shape or a square shape. In embodiments, the trench 303 may have a width W1 and a length L1, while the trench 305 may have a width W2 and a length L2. In some embodiments, the width W1 may be different from the width W2, or the length L1 may be different from the length L2. In some other embodiments, the width W1 may be the same as the width W2, and the length L1 may be the same as the length L2. In embodiments, the width W1, the width W2, the length L1, or the length L2 may be in a range of about 0.1 mm to about 0.8 mm.

A trench may have a pitch. For example, a pitch P1 of the trench 305 may be a sum of the width of the wall in line i+1, D1, and the width of the trench 305, W2. In some embodiments, a pitch of a trench may be in a range of about 0.2 mm to about 1.0 mm.

An array of trenches containing a first trench and a second trench with a different length or a different width may be referred to as a non-periodic array of trenches. Alternatively, when a trench of the array of trenches has a same width and a same length as all other trenches of the array of trenches, the array of trenches may be referred to as a periodic array of trenches. In embodiments, an optical imaging device with a non-periodic array may be used as a display screen, where a width or a length of a trench may be gradually reduced from one side of the substrate to an opposite side of the substrate, or the pitch could change or increase radially outwards from a center of the optical imaging device 300.

FIG. 4 illustrates a three-dimensional view of the optical imaging device 300 having a reflective layer 327 conformally covering the side surface of the wall of the trench of the array of trenches in the substrate 301, according to various embodiments. The reflective layer 327 may be formed as a result of the operations shown in block 205 of FIG. 2.

In some embodiments, the trench 303 and the trench 305 in the substrate 301 may be the same as the trenches in FIG. 3. In more detail, the trench 303 may be formed by the wall of the line i, and the wall of the line i+1, intersecting with the wall of the line j+1, and the wall of the line j+2. The wall of the line i+2 may include the top surface 313 and the side surface 315 coupled with the top surface 313. The wall of the line j+1 may include the top surface 323 and the side surface 325 coupled with the top surface 323. The reflective layer 327 may be deposited conformally, to cover the side surface 315 of the wall of the trench 305, and the side surface 325 of the wall of the trench 303.

FIGS. 5(a)-5(b) illustrate three-dimensional views of the optical imaging device 300 having a supporting layer 328 above the substrate 301, or a supporting layer 329 within the array of trenches. The supporting layer 328 and/or the supporting layer 329 may be formed as a result of the operations shown in block 207 of FIG. 2. In embodiments, the optical imaging device 300 having the supporting layer 328 may have a total thickness of a few millimeters. In some other embodiments, the supporting layer 328 may have a thickness the same as the substrate 301. In some embodiments, the supporting layer 328 may have a thickness in a range of about 0.8 mm to about 4.5 mm.

FIG. 5(a) illustrates a three-dimensional view of the supporting layer 328 above the substrate 301, to provide mechanical support for the array of trenches. The trench 303 and the trench 305 in the substrate 301 may be the same as the trenches in FIG. 3. The reflective layer 327 may be deposited conformally, to cover the side surfaces of the walls. The supporting layer 328 may be placed above the top surface 323. The trench 303 and/or the trench 305 may or may not include an air gap filling the trench under the supporting layer 328. The supporting layer 328 may be an optically transparent sheet that is used to improve mechanical robustness.

FIG. 5(b) illustrates a three-dimensional view of the supporting layer 329 within the array of trenches, to provide mechanical support for the array of trenches. The trench 303 and the trench 305 in the substrate 301 may be the same as the trenches in FIG. 3. The reflective layer 327 may be deposited conformally, to cover the side surfaces of the walls. The supporting layer 329 may be placed within the array of trenches, next to the reflective layer 327.

In embodiments, a privacy film may be further placed above the substrate 301 or the supporting layer 328 to remove secondary images of the optical imaging device 300.

FIGS. 6(a)-6(d) illustrate cross-section views of an apparatus at various stages of fabrication following a process 600 for making an optical imaging device based on a micro mirror array in a substrate 601, according to various embodiments.

As shown in FIG. 6(a), an array of trenches, e.g., a trench 603 and a trench 605, may be formed in the substrate 601. In embodiments, the substrate 601 may include an optically transparent material, such as glass, PMMA, or PDMS. The trench 603 and the trench 605 may be separated by a wall, e.g., a wall 611. The wall 611 may include a side surface 615 coupled with a top surface 613. In some embodiments, the trench 603 and/or the trench 605 may not extend completely through the substrate 601 in the vertical direction.

As shown in FIG. 6(b), a reflective layer 627 may be formed to serve as a reflector. In embodiments, the reflective layer 627 may conformally cover the side surfaces 615 of the wall 611. In embodiments, the reflective layer 627 may include aluminum, gold, silver, or other reflective materials.

As shown in FIG. 6(c), a supporting layer 628 may be formed covering the top surface 613 of the substrate 601 and the reflective layer 627. The supporting layer 628 may provide mechanical support for the array of trenches, e.g., the trench 603 and the trench 605, and the wall 611. In some embodiments, the supporting layer 628 may include a flat sheet having an optically transparent material, such as glass.

As shown in FIG. 6(d), alternatively, a supporting layer 629 may be formed next to the reflective layer 627 to fill the trenches. The supporting layer 629 may provide mechanical support for the array of trenches and the wall 611. In some embodiments, the supporting layer 629 may include an optically transparent material, such as PDMS or PMMA.

FIGS. 7(a)-7(c) and 8(a)-8(c) illustrate different embodiments of fabrication of the array of trenches in a substrate. The illustrated embodiments may be examples of the operations shown in block 203 in FIG. 2. The illustrated embodiments may be used to form the array of trenches shown in FIG. 3 or shown in FIG. 6.

FIGS. 7(a)-7(c) illustrate an embodiment 700 for making an array of trenches in a substrate 701, according to various embodiments.

As shown in FIG. 7(a), a substrate 701 may be provided. The substrate 701 may include a ceramic material, e.g., glass.

As shown in FIG. 7(b), a photoresist layer 702 may be formed to have a pattern. The areas covered by the patterned photoresist layer 702 may become walls of an array of trenches to be formed. For example, the area covered by the photoresist layer 702 may become a wall similar to the wall 611 of FIG. 6.

As shown in FIG. 7(c), an array of trenches may be formed, e.g., a trench 703 and a trench 705. The array of trenches may be formed by etching, e.g., wet etching or reactive ion etching, to remove areas not covered by the photoresist layer 702. After the array of trenches is formed, the photoresist layer 702 may be removed. The area previously covered by the patterned photoresist layer 702 may become walls of the trenches. For example, the area covered by the photoresist layer 702 in FIG. 7(b) may become a wall 711. The wall 711 may have a top surface 713 coupled to a side surface 715.

FIGS. 8(a)-8(c) illustrate another embodiment 800 for making an array of trenches in a substrate 801, according to various embodiments.

As shown in FIG. 8(a), a substrate 801 may be provided. The substrate 801 may include a polymer material, e.g., PDMS or PMMA.

As shown in FIG. 8(b), a hard template 802 or a stamp 802 may be used to emboss the substrate 801 to create trenches. The hard template 802 or the stamp 802 may cut partially through the substrate 801 in the vertical direction. Alternatively, the hard template 802 or the stamp 802 may cut completely through the substrate 801 in the vertical direction.

As shown in FIG. 8(c), the hard template 802 or the stamp 802 may be removed from the substrate 801. The substrate 801 may be cured. An array of trenches, e.g., a trench 803 and a trench 805, may be formed. The trench 803 and the trench 805 may be separated by a wall 811. The wall 811 may have a top surface 813 coupled to a side surface 815.

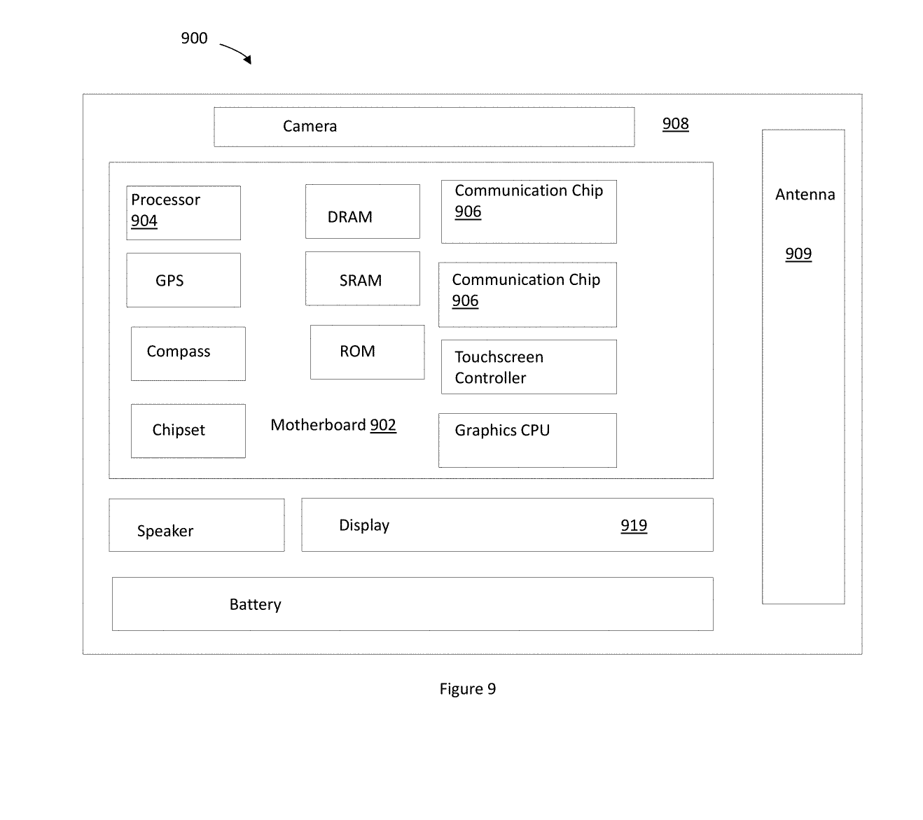

FIG. 9 illustrates an example computing device 900 that may employ the apparatuses and/or methods described herein, according to various embodiments.

Components of the computing device 900 may be housed in an enclosure (e.g., housing 908). The motherboard 902 may include a number of components, including but not limited to a processor 904 and at least one communication chip 906. The processor 904 may be physically and electrically coupled to the motherboard 902. In some implementations, the at least one communication chip 906 may also be physically and electrically coupled to the motherboard 902. In further implementations, the communication chip 906 may be part of the processor 904. In addition, the computing device 900 may further include an antenna 909.

The computing device 900 may include a display 919. The display 919 may include an optical imaging device, e.g., the optical imaging device 101, the optical imaging device 120, the optical imaging device 121, the optical imaging device 300, or the optical imaging device made by the process 200 or the process 600. The optical imaging device may be a passive element of the display 919, without electronic or mechanical control to change the display content dynamically. In addition, the display 919 may further include an active element where the content of the active element may be updated. The passive element of the display 919, e.g., the optical imaging device, and the active element of the display 919 together may form a display in fixed geometry to show images. The display 919 may be used as a display in ATMs, digital signage, medical imaging, gaming, video-conferencing, and any kind of display installations.

Depending on its applications, the computing device 900 may include other components that may or may not be physically and electrically coupled to the motherboard 902. These other components may include, but are not limited to, volatile memory (e.g., dynamic random access memory (DRAM), static random access memory (SRAM), non-volatile memory (e.g., ROM), flash memory, a graphics central processing unit (CPU), a digital signal processor, a crypto processor, a chipset, a display, a touchscreen display, a touchscreen controller, a battery, an audio codec, a video codec, a power amplifier, a global positioning system (GPS) device, a compass, a Geiger counter, an accelerometer, a gyroscope, a speaker, a camera, and a mass storage device (such as hard disk drive, compact disk (CD), digital versatile disk (DVD), and so forth).

The communication chip 906 may enable wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible broadband wireless access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 906 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 906 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 906 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip 906 may operate in accordance with other wireless protocols in other embodiments.

The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, EV-DO, and others.

In various implementations, the computing device 900 may be a mobile computing device, a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 900 may be any other electronic device that processes data.

Thus various example embodiments of the present disclosure have been described including, but are not limited to:

Example 1 may include a method for making an optical imaging device, comprising: forming an array of trenches in a substrate, wherein the forming includes intersecting a first plurality of walls with a second plurality of walls in the substrate, to provide a trench of the array of trenches by adjacent walls of the first plurality of walls and intersecting adjacent walls of the second plurality of walls, wherein a wall of the trench includes a side surface coupled with a top surface; and depositing a reflective layer conformally covering the side surface of the wall of the trench of the array of trenches to serve as a reflector.

Example 2 may include the method of example 1 and/or some other examples herein, wherein the intersecting of the first plurality of walls with the second plurality of walls further includes intersecting the first plurality of walls substantially orthogonally to the second plurality of walls.

Example 3 may include the method of example 1 and/or some other examples herein, further comprising: forming a supporting layer above the substrate, or within the array of trenches, to provide mechanical support for the array of trenches.

Example 4 may include the method of any of examples 1-3 and/or some other examples herein, further including: forming a privacy film covering the supporting layer.

Example 5 may include the method of any of examples 1-3 and/or some other examples herein, wherein the substrate includes glass, polymethyl methacrylate (PMMA), or polydimethylsiloxane (PDMS).

Example 6 may include the method of any of examples 1-3 and/or some other examples herein, wherein the reflective layer includes aluminum, gold, or silver.

Example 7 may include the method of any of examples 1-3 and/or some other examples herein, wherein a cross-section of each trench of the array of trenches is of a rectangular shape or a square shape.

Example 8 may include the method of any of examples 1-3 and/or some other examples herein, wherein the array of trenches includes a first trench and a second trench, a cross-section of the first trench is of a first rectangle shape, and a cross-section of the second trench is of a second rectangle shape, and wherein the first rectangle has a first length and a first width, the second rectangle has a second length and a second width, and wherein the first length is different from the second length, or the first width is different from the second width.

Example 9 may include the method of any of examples 1-3 and/or some other examples herein, wherein the supporting layer disposed above the substrate includes a flat sheet having an optically transparent material.

Example 10 may include the method of any of examples 1-3 and/or some other examples herein, wherein the supporting layer disposed within the array of trenches includes an optically transparent material filling the array of trenches.

Example 11 may include an optical imaging apparatus, comprising: a substrate, wherein the substrate is optically transparent, and includes an array of trenches formed by a first plurality of walls intersected with a second plurality of walls in the substrate, a trench of the array of trenches is formed by adjacent walls of the first plurality of walls intersected with adjacent walls of the second plurality of walls, wherein a wall of the trench includes a side surface coupled with a top surface; and a reflective layer disposed on the substrate to conformally cover the side surface of the wall of the trench of the array of trenches to serve as a reflector.

Example 12 may include the optical imaging apparatus of example 11 and/or some other examples herein, wherein the substrate includes glass, polymethyl methacrylate (PMMA), or polydimethylsiloxane (PDMS).

Example 13 may include the optical imaging apparatus of example 11 and/or some other examples herein, wherein the reflective layer includes aluminum, gold, or silver.

Example 14 may include the optical imaging apparatus of example 11 and/or some other examples herein, wherein the array of trenches includes a first trench and a second trench, a cross-section of the first trench is of a first rectangle shape, and a cross-section of the second trench is of a second rectangle shape, and wherein the first rectangle has a first length and a first width, the second rectangle has a second length and a second width, and wherein the first length is different from the second length, or the first width is different from the second width.

Example 15 may include the optical imaging apparatus of example 11 and/or some other examples herein, wherein the trench of the array of trenches has a length or a width in a range of about 0.1 mm to about 0.8 mm.

Example 16 may include the optical imaging apparatus of example 11 and/or some other examples herein, wherein a thickness of the substrate is in a range of about 0.25 mm to about 4.5 mm.

Example 17 may include the optical imaging apparatus of any of examples 11-16 and/or some other examples herein, further comprising: a supporting layer disposed above the substrate, or within the array of trenches, to provide mechanical support for the array of trenches.

Example 18 may include the optical imaging apparatus of example 17 and/or some other examples herein, wherein the supporting layer disposed above the substrate includes a flat sheet having an optically transparent material.

Example 19 may include the optical imaging apparatus of example 18 and/or some other examples herein, wherein the flat sheet covers a trench of the array of trenches, and wherein the trench includes an air gap filling the trench under the flat sheet.

Example 20 may include the optical imaging apparatus of example 17 and/or some other examples herein, wherein the supporting layer disposed within the array of trenches includes an optically transparent material filling the array of trenches.

Example 21 may include the optical imaging apparatus of example 17 and/or some other examples herein, further comprising: a privacy film covering the supporting layer.

Example 22 may include an electronic system, comprising: a printed circuit board (PCB); and a display coupled to the PCB, wherein the display includes an optical imaging device, and wherein the optical imaging device includes: a substrate, wherein the substrate is optically transparent, and includes an array of trenches formed by a first plurality of walls intersected with a second plurality of walls in the substrate, a trench of the array of trenches is formed by adjacent walls of the first plurality of walls intersected with adjacent walls of the second plurality of walls, wherein a wall of the trench includes a side surface coupled with a top surface; a reflective layer disposed on the substrate to conformally cover the side surface of the wall of the trench of the array of trenches to serve as a reflector; and a supporting layer disposed above the substrate, or within the array of trenches, to provide mechanical support for the array of trenches.

Example 23 may include the electronic system of example 22 and/or some other examples herein, wherein the substrate includes glass, polymethyl methacrylate (PMMA), or polydimethylsiloxane (PDMS).

Example 24 may include the electronic system of any of examples 22-23 and/or some other examples herein, wherein the reflective layer includes aluminum, gold, or silver.

Example 25 may include the electronic system of any of examples 22-23 and/or some other examples herein, wherein the electronic system is a wearable device or a mobile computing device.

It will be apparent to those skilled in the art that various modifications and variations may be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for making an optical imaging device, comprising:
forming an array of trenches in a substrate, wherein the forming includes intersecting a first plurality of walls with a second plurality of walls in the substrate, to provide a trench of the array of trenches by adjacent walls of the first plurality of walls and intersecting adjacent walls of the second plurality of walls, wherein a wall of the trench includes a side surface coupled with a top surface; and
depositing a reflective layer conformally covering the side surface of the wall of the trench of the array of trenches to serve as a reflector.

2. The method of claim 1, wherein the intersecting of the first plurality of walls with the second plurality of walls further includes intersecting the first plurality of walls substantially orthogonally to the second plurality of walls.

3. The method of claim 1, further comprising:
forming a supporting layer above the substrate, or within the array of trenches, to provide mechanical support for the array of trenches.

4. The method of claim 3, further including:
forming a privacy film covering the supporting layer.

5. The method of claim 1, wherein the substrate includes glass, polymethyl methacrylate (PMMA), or polydimethylsiloxane (PDMS).

6. The method of claim 1, wherein the reflective layer includes aluminum, gold, or silver.

7. The method of claim 1, wherein a cross-section of each trench of the array of trenches is of a rectangular shape or a square shape.

8. The method of claim 1, wherein the array of trenches includes a first trench and a second trench, a cross-section of the first trench is of a first rectangle shape, and a cross-section of the second trench is of a second rectangle shape, and wherein the first rectangle has a first length and a first width, the second rectangle has a second length and a second width, and wherein the first length is different from the second length, or the first width is different from the second width.

9. The method of claim 3, wherein the supporting layer disposed above the substrate includes a flat sheet having an optically transparent material.

10. The method of claim 3, wherein the supporting layer disposed within the array of trenches includes an optically transparent material filling the array of trenches.

11. An optical imaging apparatus, comprising:
a substrate, wherein the substrate is optically transparent, and includes an array of trenches formed by a first plurality of walls intersected with a second plurality of walls in the substrate, a trench of the array of trenches is formed by adjacent walls of the first plurality of walls intersected with adjacent walls of the second plurality of walls, wherein a wall of the trench includes a side surface coupled with a top surface; and
a reflective layer disposed on the substrate to conformally cover the side surface of the wall of the trench of the array of trenches to serve as a reflector.

12. The optical imaging apparatus of claim 11, wherein the substrate includes glass, polymethyl methacrylate (PMMA), or polydimethylsiloxane (PDMS).

13. The optical imaging apparatus of claim 11, wherein the reflective layer includes aluminum, gold, or silver.

14. The optical imaging apparatus of claim 11, wherein the array of trenches includes a first trench and a second trench, a cross-section of the first trench is of a first rectangle shape, and a cross-section of the second trench is of a second rectangle shape, and wherein the first rectangle has a first length and a first width, the second rectangle has a second length and a second width, and wherein the first length is different from the second length, or the first width is different from the second width.

15. The optical imaging apparatus of claim 11, wherein the trench of the array of trenches has a length or a width in a range of about 0.1 mm to about 0.8 mm.

16. The optical imaging apparatus of claim 11, wherein a thickness of the substrate is in a range of about 0.25 mm to about 4.5 mm.

17. The optical imaging apparatus of claim 11, further comprising:
a supporting layer disposed above the substrate, or within the array of trenches, to provide mechanical support for the array of trenches.

18. The optical imaging apparatus of claim 17, wherein the supporting layer disposed above the substrate includes a flat sheet having an optically transparent material.

19. The optical imaging apparatus of claim 18, wherein the flat sheet covers a trench of the array of trenches, and wherein the trench includes an air gap filling the trench under the flat sheet.

20. The optical imaging apparatus of claim 17, wherein the supporting layer disposed within the array of trenches includes an optically transparent material filling the array of trenches.

21. The optical imaging apparatus of claim 17, further comprising:
a privacy film covering the supporting layer.

22. An electronic system, comprising:
a printed circuit board (PCB); and
a display coupled to the PCB, wherein the display includes an optical imaging device, and wherein the optical imaging device includes:
a substrate, wherein the substrate is optically transparent, and includes an array of trenches formed by a first plurality of walls intersected with a second plurality of walls in the substrate, a trench of the array of trenches is formed by adjacent walls of the first plurality of walls intersected with adjacent walls of the second plurality of walls, wherein a wall of the trench includes a side surface coupled with a top surface;
a reflective layer disposed on the substrate to conformally cover the side surface of the wall of the trench of the array of trenches to serve as a reflector; and
a supporting layer disposed above the substrate, or within the array of trenches, to provide mechanical support for the array of trenches.

23. The electronic system of claim 22, wherein the substrate includes glass, polymethyl methacrylate (PMMA), or polydimethylsiloxane (PDMS).

24. The electronic system of claim 22, wherein the reflective layer includes aluminum, gold, or silver.

25. The electronic system of claim 22, wherein the electronic system is a wearable device or a mobile computing device.
